(19) United States
(12) Patent Application Publication
(10) Pub. No.: US 2017/0252851 A1
(43) Pub. Date: Sep. 7, 2017

(54) ADDITIVE MANUFACTURING WITH METALLIC COMPOSITES

(71) Applicant: Desktop Metal, Inc., Lexington, MA (US)

(72) Inventors: Ric Fulop, Lexington, MA (US); Michael Andrew Gibson, Boston, MA (US); Emanuel Michael Sachs, Newton, MA (US); Jonah Samuel Myerberg, Lexington, MA (US)

(21) Appl. No.: 15/059,256

(22) Filed: Mar. 2, 2016

(51) Int. Cl. B23K 11/00; B23K 9/04; B33Y 70/00; B33Y 10/00; B33Y 30/00

(52) U.S. Cl. CPC B23K 11/0013; B33Y 10/00; B33Y 30/00; B33Y 70/00; B23K 9/044

(57) ABSTRACT

A class of metallic composites is described with advantageous bulk properties for additive fabrication. In particular, the composites described herein can be used in fused filament fabrication or any other extrusion or deposition-based three-dimensional printing process.

### FIELD

The systems and methods described herein relate to additive manufacturing, and more specifically to three-dimensional printing with metallic composites.

### BACKGROUND

Fused filament fabrication was devised in the late 1980's as a technique for fabricating three-dimensional objects from a thermoplastic or similar material. Machines using this technique can fabricate three-dimensional objects additively by depositing lines of material in layers. Attempts to adapt these techniques to metallic fabrication have been generally unsuccessful, and there remains a need for three-dimensional printing techniques suitable for metal additive manufacturing.

### SUMMARY

A class of metallic composites is described with advantageous bulk properties for additive fabrication. In particular, the composites described herein can be used in fused filament fabrication or any other extrusion or deposition-based three-dimensional printing process.

### BRIEF DESCRIPTION OF THE DRAWINGS

The systems and methods described herein are set forth in the appended claims. However, for the purpose of explanation, several implementations are set forth in the following drawings:

FIG. 1 is a block diagram of an additive manufacturing system for use with composites.

FIG. 2 shows a flow chart of a method for printing with composites.

### DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

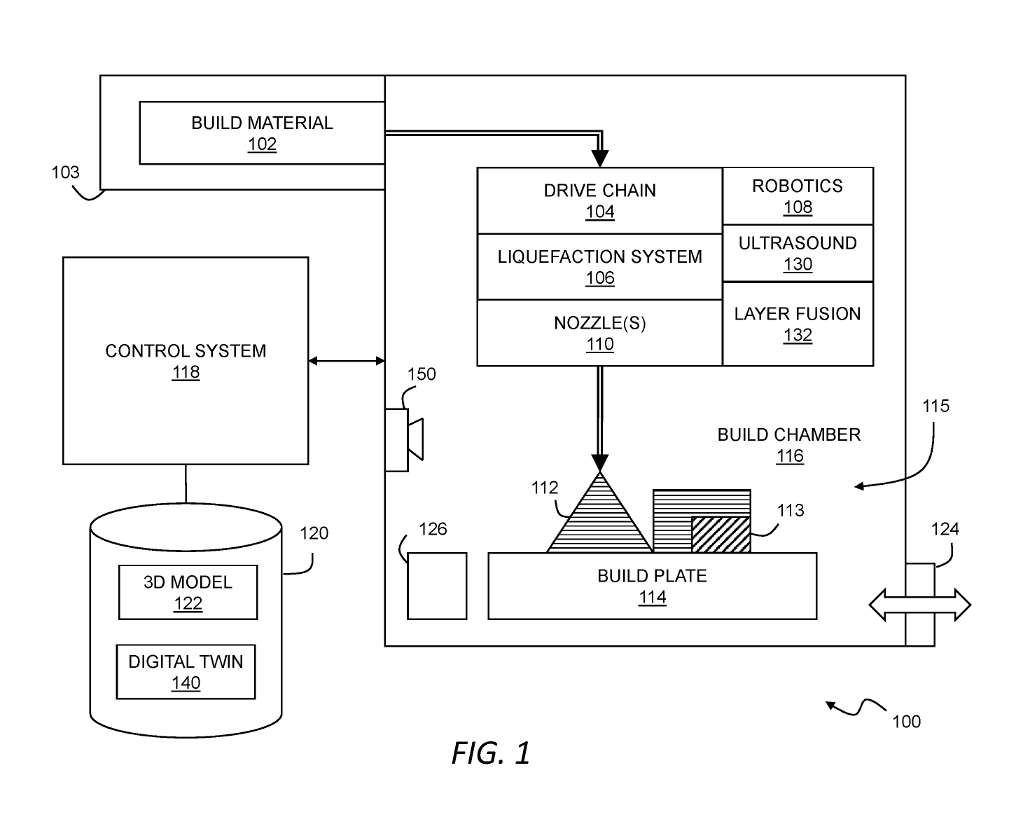

FIG. 1 is a block diagram of an additive manufacturing system for use with composites. The additive manufacturing system may include a three-dimensional printer 100 (or simply printer 100) that deposits metal using fused filament fabrication. Fused filament fabrication is well known in the art, and may be usefully employed for additive manufacturing with suitable adaptations to accommodate the forces, temperatures and other environmental requirements typical of the metallic composites contemplated herein. In general, the printer 100 may include a build material 102 that is propelled by a drive chain 104 and heated to a workable state by a liquefaction system 106, and then dispensed through one or more nozzles 110. By concurrently controlling robotic system 108 to position the nozzle(s) along an extrusion path, an object 112 may be fabricated on a build plate 114 within a build chamber 116. In general, a control system 118 manages operation of the printer 100 to fabricate the object 112 according to a three-dimensional model using a fused filament fabrication process or the like.

The following description emphasizes the use of fused filament fabrication. However, it will be readily appreciated that the composite materials described herein are useful in a wider variety of fabrication processes the may differ significantly from fused filament fabrication. For example, the composite materials may be heated to a paste or other softened state suitable for pneumatic extrusion, spread forming, piston extrusion and so forth, and the composite material may be provided as a bulk material to extrusion processes in a variety of form factors including pellets, bars, rods, powder and so forth. Thus system components such as the liquefaction system, robotic system, and drive system should be broadly construed to include any systems or subsystems suitable for depositing composite materials to form a three-dimensional structure, unless a more specific meaning is explicitly provided or otherwise clear from the context.

The build material 102 may, for example, include a composite formed of a metallic base and a second phase. The metallic base may include any metal or metal alloy (or combination of alloys) that melts at a first temperature. The second phase may be a high temperature inert second phase in particle form that remains substantially inert up to at least a second temperature that is higher than the first temperature, preferably substantially higher in order to provide a useful working range of temperatures where the metallic base can melt while the second phase remains inert. In general, this combination enables the use of a relatively low-temperature metallic alloy as a base material that can be easily melted, while providing a useful working range above the melting temperature where the composite exhibits properties suitable for extrusion or other dispensing operations. For example, the composite may, within the working temperature range, form a non-Newtonian paste or Bingham fluid with a non-zero shear stress at zero shear strain. While the viscous fluid nature of the composite permits extrusion or other similar deposition techniques, this non-Newtonian characteristic can permit the deposited material to retain its shape against the force of gravity so that a printed object can retain a desired form until the composite material cools below a solidus or eutectic temperature of the metallic base.

A variety of metals and metal alloys may be used for the metallic base. For example, the metallic base may include a pure metal such as aluminum, which has a relatively low melting point. The metallic base may also or instead include an alloy. The alloy may usefully include a relatively low-melting-temperature alloy for easier handling such as aluminum copper magnesium alloys, aluminum silicon (silumin) alloys, zinc aluminum and nickel zirconium alloys. Other useful low temperature alloys include a wide range of eutectic alloys such as an iron carbon eutectic or nickel eutectics such as nickel boron. Other low temperature alloys may also or instead be used, such as commercially available casting alloys and/or brazing filler metals. More generally, any metal, alloy, or combination of alloys with a melting temperature below about six hundred to seven hundred degrees Celsius may usefully serve as a low temperature metallic base as contemplated herein. The methods, systems, and composites described herein may also, of course, be adapted to higher temperature metals and alloys, with suitable modifications to the three-dimensional printing hardware used to handle the build material and a corresponding selection of second phase material(s). Thus, the range of temperatures provided above is illustrative and not exhaustive.

The metallic base may also or instead include combinations of metals or alloys. For example, off-eutectic alloys and related alloys may provide a range of temperatures where the metallic base is in a multi-phase state, e.g., with the eutectic in a liquid phase while the related alloy remains in solid form in equilibrium with the eutectic liquid. This multi-phase condition usefully increases viscosity of the material above the pure liquid viscosity to render the material workable for three-dimensional printing without completely solidifying. Such mixtures may be usefully employed to further control viscosity in the composites contemplated herein. In another aspect, an inert second phase may be used with a substantially pure eutectic alloy. This combination provides a dual advantage of the relatively low melting temperature that is characteristic of eutectic alloys, along with the desirable flow characteristics that can be imparted by an added inert second phase.

In general, where multiple metals and/or alloys or present, the “melting point” will be the highest melting point of all of the metals and alloys in the mixture (exclusive of any inert second phase or other particles), unless a different intent is explicitly provided or otherwise clear from the context. However, a working temperature range for extrusion may begin below this aggregate melting point, such as at a lower melting point of a eutectic alloy within the metallic base where the aggregate material is in a two-phase region including a liquid and a solid.

A wide range of bulk metallic glass forming alloys—metal alloys supercooled in a solid, amorphous state—also have an intermediate, plastic-like working range. These materials may be used to impart greater viscosity to the metallic base within various temperature ranges. A useful range of bulk metallic glasses is described by way of non-limiting example in commonly-owned U.S. Prov. App. No. 62/268,458 filed on Dec. 16, 2015, the entire content of which is hereby incorporated by reference.

In general, a relatively high-temperature inert second phase may be added in particle form to the metallic base in sufficient volume to yield a composite with a viscosity useful for printing/extrusion while the composite is within a working temperature range that lies above the melting point of the metallic base. There may be a sufficient volume of the high temperature inert second phase added to the composite to increase a viscosity of the composite (while in the working temperature range) by at least an order of magnitude or by at least two orders of magnitude relative to the unmodified metallic base.

For the ceramics and similar materials described below, the volume fraction of particulates needed to achieve easily-printed viscosities will be a function of the particle size. At the same volumetric loading, smaller particle sizes are associated with increased viscosities. For larger particles, between thirty and one hundred micrometers in diameters, loadings of twenty to fifty percent by volume have been observed to yield highly printable composites, while for smaller particle sizes between three hundred nanometers and three micrometers in diameter, loadings of twenty percent by volume have been observed to be too viscous for printing, with printable composites occurring at five to twenty percent by volume inert second phase. Thus it will be appreciated by one skilled in the art that, while loading may be used independently to control viscosity, the particle size of the inert second phase may also or instead be tuned to adjust the desired volume fraction of inert second phase. Other loadings may also or instead be used according to the types of materials used and the desired change in physical properties. It will be noted that many ceramics are also significantly less dense than the metals used in the metallic base, and the resulting composite may also advantageously be significantly lighter. The resulting composite may also be significantly stronger than the metallic base.

While viscosity provides a useful and objective metric for measuring the change in the properties of the metallic base when it is heated to within the working temperature range (e.g., above the melting temperature), it will be appreciated that other useful metrics exist, such as yield stress. With sufficient loading of a second phase, the composite can become a non-Newtonian paste with a non-zero shear stress at zero shear strain or, stated differently, with a yield stress relationship that does not intercept the stress-strain origin so that a mass of the material tends to retain its shape against external forces. For example, these non-Newtonian fluids will only flow in the presence of gravity if the force of gravity is sufficient to overcome the yield stress for the material. More generally, these materials will retain a shape unless a pressure is applied in excess of the yield stress. While this property of shape retention is a useful property of certain non-Newtonian fluids for three-dimensional printing, other materials may also be used. For example, a composite that acts as a Newtonian fluid when within the working temperature range may still be useful if the heated composite is sufficiently viscous for extrusion and the composite can cool to solidify before excessive deformation—that is, before the deposited shape changes in a manner that detrimentally impacts the overall shape of an object being manufactured. Thus in certain aspects mixtures that form Newtonian fluids within the working temperature range may also or instead be used.

A variety of materials may be used as a high temperature inert second phase. The second phase may, for example include a ceramic such as an oxide, a nitride or a carbide or any other ceramic, as well as combinations of the foregoing. Specific, non-limiting examples of such ceramic second phases include silicon carbide, aluminum oxide (Al2O3), and titanium nitride. In another aspect, the high temperature inert second phase may include a high-temperature intermetallic. In general, an intermetallic may include any solid phase with two or more metallic elements, and optionally one or more non-metallic elements, with a crystal structure differing from its constituents. In this context, high temperature intermetallics may include any intermetallics with a melting temperature substantially above the melting temperature of the metallic base to which it is added. For example, a difference in melting temperature of at least fifty degrees to one hundred degrees Celsius provides a useful range of working temperatures for a viscous composite (although practical inert second phases may provide a range of working temperatures of several hundred degrees or more). More generally, the second phase should remain inert at a sufficiently high temperature to provide a useful range of working temperatures for the composite. Thus, for metallic or intermetallic second phases, a higher temperature range may usefully ensure that the second phase remains inert and does not tend to alloy or otherwise react with the metallic base. In another aspect, the second phase may include a pure metal or alloy or any other material or combination of materials that are substantially inert within the working temperature range.

In this context, it will be understood that the term “inert” is intended to mean that a material is not substantially chemically reactive within the relevant temperature range and over the timescales of a printing process, and still more generally that a material remains sufficiently unchanged in physical, chemical and mechanical properties so that the second phase can continue to contribute to the desired properties (e.g., viscosity, yield stress) within the working temperature range. Thus for example, inert particles in this context will not crystallize, liquefy, oxidize, react, or otherwise interact significantly with other materials in the metallic base, and will not change physical, mechanical, or chemical properties within the composite while within the working temperature range. The particles may also or instead be inert as a result of a reacted surface of the particles, or some other surface condition or property thereof, even when the base material is not inherently inert. Thus it is more generally contemplated that within the working temperature range, the metallic base will liquefy, while the second phase will retain its physical characteristics so that the viscosity or yield stress of the composite can be maintained in a range suitable for use in additive manufacturing as contemplated herein.

In general, the particle size of the second phase material may be controlled to modify the mechanical interface with the metallic base and the resulting viscosity. The high temperature inert second phase may, for example, consist of particles having a size not greater than one-half micron, not greater than one micron (typically achieved with ball milling or similar processes), not greater than five microns or not greater than thirty microns. Particle sizes above fifty microns may also be used as a viscosity-controlling additive for a metallic base, but larger particles may begin to effect the useful print resolution for a three-dimensional printer, and will not contribute as substantially to increasing the yield stress of the printed composite. Thus it will be appreciated that smaller size particles may thus be preferred for a variety of printing processes, and that particles of one-half micron or smaller may also usefully be employed subject to practical limits on manufacturing of such composites. In general, the particle size as used herein is intended to refer to a maximum particle size as measured along a longest dimension of each particle. However, other measures may also or instead be used to characterize particle dimensions such as a particle volume, a particle mass, a particle surface area, or an average or distribution of any of the foregoing or any other objective measure.

A variety of useful composites are commercially available, and/or may be engineered for different temperature ranges and metals or alloys using the parameters described above. For example, a useful composite may be formed by ball milling a material such as a ceramic or other high-temperature inert second phase into a powder of suitable size (e.g., one micron, or any other suitable dimension). The metallic base may optionally be ball milled or otherwise processed into a powder, and the metallic base and second phase may then be mixed and formed using hot isostatic pressing or any other suitable technique to form the mixture into a billet or other form for handling by the three-dimensional printer 100. Hot isostatic pressing, in particular, may encourage bonding within the powder mixture and reduce porosity of the metallic base to improve density and workability of the formed part for use in a three-dimensional printing process.

It will also be appreciated that the shape of particles in the second phase may have a substantial impact on the physical properties of the composite within the working temperature range. Different techniques may be used to create particles of different size and shapes, e.g., particles that are more generally rounded, polyhedral, spiky, planar, elongated, and/or irregular according to the desired properties of the resulting paste. In general, more irregular and varied geometries can reduce the loading required to achieve a particular viscosity or yield stress within the working temperature.

The build material 102 may be fed from a carrier 103 configured to dispense the build material to the three-dimensional printer either in a continuous (e.g., wire) or discrete (e.g., billet) form. The build material 102 may for example be supplied in discrete units one by one as billets or the like into an intermediate chamber for delivery into the build chamber 118 and subsequent melt and deposition In another aspect, the carrier 103 may include a spool or cartridge containing the build material 102 in a wire form. In this aspect, the wire may be fed through a vacuum gasket into the build chamber 118 in a continuous fashion. Thus in one aspect, there is disclosed herein an apparatus including a build material formed into a wire, the build material including a composite formed of a metallic base that melts at a first temperature and a high temperature inert second phase that remains inert to at least a second temperature above the first temperature, and a carrier bearing the build material, wherein the carrier is configured to dispense the build material in a continuous feed to a three-dimensional printer. For environmentally sensitive materials, the carrier 103 may provide a vacuum environment for the build material 102 that can be directly or indirectly coupled to the vacuum environment of the build chamber 118. More generally, the build chamber 118 (and the carrier 103) may maintain any suitably inert environment for handling of the build material 102, such as a vacuum, and oxygen-depleted environment, an inert gas environment, or some gas or combination of gasses that are not reactive with the build material 102 under the conditions maintained during three-dimensional fabrication.

A drive chain 104 may include any suitable gears, compression pistons, or the like for continuous or indexed feeding of the build material 116 into the liquefaction system 106. In one aspect, the drive chain 104 may include gear shaped to mesh with corresponding features in the build material such as ridges, notches, or other positive or negative detents. In another aspect, the drive chain 104 may use heated gears or screw mechanisms to deform and engage with the build material. Thus there is disclosed in one aspect a printer for a fused filament fabrication process that heats a composite with a metallic base to a temperature above a melting temperature of the metallic base for plastic extrusion, and that heats a gear that engages with, deforms, and drives the composite in a feed path.

In another aspect, the drive chain 104 may use bellows, or any other collapsible or telescoping press to drive rods, billets, or similar units of build material into the liquefaction system 106. Similarly, a piezoelectric or linear stepper drive may be used to advance a unit of build media in a non-continuous, stepped method with discrete, high-powered mechanical increments. In another aspect, the drive chain 104 may include multiple stages. In a first stage, the drive chain 104 may heat the composite material and form threads or other features that can supply positive gripping traction into the material. In the next stage, a gear or the like matching these features can be used to advance the build material along the feed path. More generally, the drive chain 104 may include any mechanism or combination of mechanisms used to advance build material 102 for deposition in a three-dimensional fabrication process. Thus, the term “drive chain” should be interpreted in the broadest sense, unless a more specific meaning is explicitly provided or otherwise clear from the context.

The liquefaction system 106 may be any liquefaction system configured to heat the composite to a working temperature in a range between the first temperature of the metallic base and a second temperature of the high temperature inert second phase. Any number of heating techniques may be used. In one aspect, electrical techniques such as inductive or resistive heating may be usefully applied to liquefy the build material 102. This may, for example include inductively or resistively heating a chamber around the build material 102 to a temperature above the melting point of the composite, or this may include directly heating the composite itself. Because the contemplated composites are metallic and conductive, they may be directly heated through contact methods (e.g., resistive heating with applied current) or non-contact methods (e.g., induction heating using an external electromagnet to drive eddy currents within the material). The choice of additives may further be advantageously selected to provide a bulk electrical characteristics (e.g., conductance/resistivity) to improve heating. When directly heating the build material 102, it may be useful to model the shape and size of the build material 102 in order to better control electrically-induced heating. This may include estimates or actual measurements of shape, size, mass, etc.

It will also be appreciated that in this context, “liquefaction” does not require complete liquefaction. That is, the media to be used in printing may be in a multi-phase state, and/or form a paste or the like having highly viscous and/or non-Newtonian fluid properties. Thus the liquefaction system 106 described herein should be understood to more generally include any system that places a build material 102 in condition for use in fabrication as contemplated herein.

In order to facilitate resistive heating of the build material 102, one or more contact pads, probes or the like may be positioned within the feed path for the material in order to provide locations for forming a circuit through the material at the appropriate location(s). In order to facilitate induction heating, one or more electromagnets may be positioned at suitable locations adjacent to the feed path and operated, e.g., by the control system 118, to heat the build material internally through the creation of eddy currents. In one aspect, both of these techniques may be used concurrently to achieve a more tightly controlled or more evenly distributed electrical heating within the build material. The printer 100 may also be instrumented to monitor the resulting heating in a variety of ways. For example, the printer 100 may monitor power delivered to the inductive or resistive circuits. The printer 100 may also or instead measure temperature of the build material 102 or surrounding environment at any number of locations. In another aspect, the temperature of the build material 102 may be inferred by measuring, e.g., the amount of force required to drive the build material 102 through a nozzle 110 or other portion of the feed path, which may be used as a proxy for the viscosity of the build material 102. More generally, any techniques suitable for measuring temperature or viscosity of the build material 102 and responsively controlling applied electrical energy may be used to control liquefaction for a fabrication process using composites as contemplated herein.

The liquefaction system 106 may also or instead include any other heating systems suitable for applying heat to the build material 102 to a suitable temperature for extrusion. This may, for example include techniques for locally or globally augmenting heating using, e.g., chemical heating, combustion, ultrasound heating, laser heating, electron beam heating or other optical or mechanical heating techniques and so forth.

The liquefaction system 106 may include a shearing engine. The shearing engine may create shear within the composite as it is heated in order to maintain a mixture of the metallic base and the second phase, or to maintain a mixture of various phases of alloys or the like in the metallic base or to otherwise control homogeneity or agglomeration within the mixture, or any combination of these. A variety of techniques may be employed by the shearing engine. In one aspect, the bulk media may be axially rotated as it is fed along the feed path into the liquefaction system 106. In another aspect, one or more ultrasonic transducers may be used to introduce shear within the heated material. Similarly, a screw, post, arm, or other physical element may be placed within the heated media and rotated or otherwise actuated to mix the heated material.

The robotic system 108 may include a robotic system configured to three-dimensionally position the nozzle 110 within the working volume 115 of the build chamber 116. This may, for example, include any robotic components or systems suitable for positioning the nozzle 110 relative to the build plate 114 while depositing the composite in a pattern to fabricate the object 112. A variety of robotics systems are known in the art and suitable for use as the robotic system 108 contemplated herein. For example, the robotics may include a Cartesian or x-y-z robotics systems employing a number of linear controls to move independently in the x-axis, the y-axis, and the z-axis within the build chamber 116. Delta robots may also or instead be usefully employed, which can, if properly configured, provide significant advantages in terms of speed and stiffness, as well as offering the design convenience of fixed motors or drive elements. Other configurations such as double or triple delta robots can increase range of motion using multiple linkages. More generally, any robotics suitable for controlled positioning of the nozzle 110 relative to the build plate 114, especially within a vacuum or similar environment, may be usefully employed including any mechanism or combination of mechanisms suitable for actuation, manipulation, locomotion and the like within the build chamber 116.

The nozzle(s) 110 may include one or more nozzles for dispensing the build material 102 that has been propelled with the drive chain 104 and heated with the liquefaction system 106 to a suitable working temperature such as a working temperature above the melting temperature of the metallic base of the composite, or more specifically between a first temperature at which the metallic base melts and the second temperature (above the first temperature) at which the second phase of the composite remains inert. The nozzles 110 may, for example, be used to dispense different types of material so that, for example, one nozzle 110 dispenses a composite build material while another nozzle 110 dispenses a support material in order to support bridges, overhangs, and other structural features of the object 112 that would otherwise violate design rules for fabrication with the composite build material. In another aspect, one of the nozzles 110 may deposit a different type of material, such as a thermally compatible polymer or a metal or polymer loaded with fibers of one or more materials to increase tensile strength or otherwise improve mechanical properties of the resulting object 112.

The nozzle 110 will preferably be formed of a material or combination of materials with suitable mechanical and thermal properties. For example, the nozzle 110 will preferably not degrade at the temperatures wherein the composite material is to be dispensed. While nozzles for traditional polymer-based fused filament fabrication may be made from aluminum alloys, a nozzle that dispenses composites containing molten aluminum cannot be made from aluminum, but must be made from a significantly higher melting temperature material, such as a stainless steel, refractory metal (e.g. molybdenum, tungsten), or refractory ceramic (e.g. mullite, corundum, magnesia). For higher melting temperature alloys, such as a nickel-zirconium eutectic, the nozzle 110 will preferably be formed of material(s) capable of sustaining temperatures above one thousand degrees Celsius without degradation, such as the previously mentioned refractory metals or ceramics.

In one aspect, the nozzle 110 may include one or more ultrasound transducers 130 as described herein. Ultrasound may be usefully applied for a variety of purposes in this context. In one aspect, the ultrasound energy may facilitate extrusion by mitigating clogging by reducing adhesion of a build material to an interior surface of the nozzle 110. In another aspect, the ultrasonic energy can be used to break up a passivation layer on a prior layer of printed media so that better layer-to-layer adhesion can be obtained. A variety of energy director techniques may be used to improve this general approach. For example, a deposited layer may include one or more ridges, which may be imposed by an exit shape of the nozzle 110, to present a focused area to receive ultrasound energy introduced into the interface between the deposited layer and an adjacent layer.

In another aspect, the nozzle 110 may include an induction heating element, resistive heating element, or similar components to directly control the temperature of the nozzle 110. This may be used to augment a more general liquefaction process along the feed path through the printer 100, e.g., to maintain a temperature of the build material 102 during fabrication, or this may be used for more specific functions, such as declogging a print head by heating the build material 102 substantially above the working range, e.g., to a temperature where the composite is liquid. While it may be difficult or impossible to control deposition in this liquid state, the heating can provide a convenient technique to reset the nozzle 110 without more severe physical intervention such as removing vacuum to disassemble, clean, and replace the affected components.

In another aspect, the nozzle 110 may include an inlet gas, e.g., an inert gas, to cool media at the moment it exits the nozzle 110. This gas jet may, for example, immediately stiffen the dispensed material to facilitate extended bridging, larger overhangs, or other structures that might otherwise require support structures underneath. A gas may also be used to assist in deposition and/or to prevent reverse material flow toward a build material source and away from the nozzle 110.

The object 112 may be any object suitable for fabrication using the techniques contemplated herein. This may include functional objects such as machine parts, aesthetic objects such as sculptures, or any other type of objects, as well as combinations of objects that can be fit within the physical constraints of the build chamber 116 and build plate 114. Some structures such as large bridges and overhangs cannot be fabricated directly using fused filament fabrication or the like because there is no underlying physical surface onto which a material can be deposited. In these instances, a support structure 113 may be fabricated, preferably of a soluble or otherwise readily removable material, in order to support the corresponding feature.

Where multiple nozzles 110 are provided, a second nozzle may usefully provide any of a variety of additional build materials. This may, for example, include other composites, alloys, bulk metallic glass's, thermally matched polymers and so forth to support fabrication of suitable support structures. In one aspect, one of the nozzles 110 may dispense a bulk metallic glass that is deposited at one temperature to fabricate a support structure 113, and a second, higher temperature at an interface to a printed object 112 where the bulk metallic glass can be crystallized at the interface to become more brittle and facilitate mechanical removal of the support structure 113 from the object 112. Conveniently, the bulk form of the support structure 113 can be left in the super-cooled state so that it can retain its bulk structure and be removed in a single piece. Thus in one aspect there is disclosed herein a printer that fabricates a portion of a support structure 113 with a bulk metallic glass in a super-cooled liquid region, and fabricates a layer of the support structure adjacent to a printed object at a greater temperature in order to crystalize the build material 102 into a non-amorphous alloy.

The build plate 114 within the working volume 115 of the build chamber 116 may include a rigid and substantially planar surface formed of any substance suitable for receiving deposited composite or other material(s)s from the nozzles 110. In one aspect, the build plate 114 may be heated, e.g., resistively or inductively, to control a temperature of the build chamber 116 or the surface upon which the object 112 is being fabricated. This may, for example, improve adhesion, prevent thermally induced deformation or failure, and facilitate relaxation of stresses within the fabricated object. In another aspect, the build plate 114 may be a deformable build plate that can bend or otherwise physical deform in order to detach from the rigid object 112 formed thereon.

The build chamber 116 may be any chamber suitable for containing the build plate 114, an object 112, and any other components of the printer 100 used within the build chamber 116 to fabricate the object 112. In one aspect, the build chamber 116 may be an environmentally sealed chamber that can be evacuated with a vacuum pump 124 or similar device in order to provide a vacuum environment for fabrication. This may be particularly useful where oxygen causes a passivation layer that might weaken layer-to-layer bonds in a fused filament fabrication process as contemplated herein.

Similarly, one or more passive or active oxygen getters 126 or other similar oxygen absorbing material or system may usefully be employed within the build chamber 116 to take up free oxygen within the build chamber 116. The oxygen getter 126 may, for example, include a deposit of a reactive material coating an inside surface of the build chamber 116 or a separate object placed therein that completes and maintains the vacuum by combining with or adsorbing residual gas molecules. The oxygen getters 126, or more generally, gas getters, may be deposited as a support material using one of the nozzles 110, which facilitates replacement of the gas getter with each new fabrication run and can advantageously position the gas getter(s) near printed media in order to more locally remove passivating gasses where new material is being deposited onto the fabricated object. In one aspect, the oxygen getters 126 may include any of a variety of materials that preferentially react with oxygen including, e.g., materials based on titanium, aluminum, and so forth. In another aspect, the oxygen getters 126 may include a chemical energy source such as a combustible gas, gas torch, catalytic heater, Bunsen burner, or other chemical and/or combustion source that reacts to extract oxygen from the environment. There are a variety of low-CO and NOx catalytic burners that may be suitably employed for this purpose without CO.

In one aspect, the oxygen getter 126 may be deposited as a separate material during a build process. Thus in one aspect there is disclosed herein a process for fabricating a three-dimensional object from a metallic composite including co-fabricating a physically adjacent structure (which may or may not directly contact the three-dimensional object) containing an agent to remove passivating gasses around the three-dimensional object. Other techniques may be similarly employed to control reactivity of the environment within the build chamber. For example, the build chamber 116 may be filled with an inert gas or the like to prevent oxidation.

Objects fabricated from metal may be heavy and difficult to move. To address these issues a scissor table or other lifting mechanism may be provided to lift fabricated objects out of the build chamber. An intermediate chamber may usefully be employed for transfers of printed objects out of the build chamber 116, and for providing build material 102 into the vacuum environment, along with corresponding robotics for picking and placing objects as appropriate.

The control system 118 may include a processor and memory, as well as any other co-processors, signal processors, inputs and outputs, digital-to-analog or analog-to-digital converters and other processing circuitry useful for monitoring and controlling a fabrication process executing on the printer 100. The control system 118 may be coupled in a communicating relationship with a supply of the build material 102, the drive chain 104, the liquefaction system 106, the nozzles 110, the build plate 114, the robotic system 108, and any other instrumentation or control components associated with the build process such as temperature sensors, pressure sensors, oxygen sensors, vacuum pumps, and so forth. The control system 118 may be operable to control the robotic system 108, the liquefaction system 106 and other components to fabricate an object 112 from the build material 102 in three dimensions within the working volume 115 of the build chamber 116.

The control system 118 may generate machine ready code for execution by the printer 100 to fabricate the object 112 from the three-dimensional model 122. The control system 118 may deploy a number of strategies to improve the resulting physical object structurally or aesthetically. For example, the control system 118 may use plowing, ironing, planing, or similar techniques where the nozzle 110 runs over existing layers of deposited material, e.g., to level the material, remove passivation layers, applies an energy director topography of peaks or ridges to improve layer-to-layer bonding, or otherwise prepare the current layer for a next layer of material. The nozzle 110 may include a non-stick surface to facilitate this plowing process, and the nozzle 110 may be heated and/or vibrated (using the ultrasound transducer) to improve the smoothing effect. In one aspect, this surface preparation may be incorporated into the initially-generated machine ready code. In another aspect, the printer 100 may dynamically monitor deposited layers and determine, on a layer-by-layer basis, whether additional surface preparation is necessary or helpful for successful completion of the object.

In one aspect, the control system 118 may employ pressure or flow rate as a process feedback signal. While temperature is frequently the critical physical quantity for fabrication with metals, it may be difficult to accurately measure the temperature of a composite build material throughout the feed path. However, the temperature can be inferred by the ductility of the build material, which can be estimated for the bulk material based on how much work is being done to drive the material through a feed path. Thus in one aspect, there is disclosed herein a printer that measures the force applied by a drive chain to a composite such as any of the composites described above, infers a temperature of the build material based on the instantaneous force, and controls a liquefaction system to adjust the temperature accordingly.

In general, a three-dimensional model 122 of the object may be stored in a database 120 such as a local memory of a computer used as the control system 118, or a remote database accessible through a server or other remote resource, or in any other computer-readable medium accessible to the control system 118. The control system 118 may retrieve a particular three-dimensional model 122 in response to user input, and generate machine-ready instructions for execution by the printer 100 to fabricate the corresponding object 112. This may include the creation of intermediate models, such as where a CAD model is converted into an STL model or other polygonal mesh or other intermediate representation, which can in turn be processed to generate machine instructions for fabrication of the object 112 by the printer 100.

In another aspect, the nozzle 110 may include one or more mechanisms to flatten a layer of deposited material and apply pressure to bond the layer to an underlying layer. For example, a heated nip roller, caster, or the like may follow the nozzle 110 in its path through an x-y plane of the build chamber to flatten the deposited (and still pliable) layer. The nozzle 110 may also or instead integrate a forming wall, planar surface or the like to additionally shape or constrain a build material 102 as it is deposited by the nozzle 110. The nozzle 110 may usefully be coated with a non-stick material (which may vary according to the build material being used) in order to facilitate more consistent shaping and smoothing by this tool.

One or more ultrasound transducers 130 or similar vibration components may be usefully deployed at a variety of locations within the printer 100. For example, a vibrating transducer may be used to vibrate pellets, particles or other similar media as it is distributed from a hopper of the build material 102 into drive chain 104. This type of agitation can more uniformly distribute the pellets for a more even flow into a screwdrive or similar mechanism and prevent jams or inconsistent feeding. In another aspect, an ultrasonic transducer 130 may be used to encourage a relatively high-viscosity composite material to deform and exit through a pressurized hot-end die of the nozzle 110. One or more dampers, mechanical decouples, or the like may be included between the nozzle 110 and other components in order to isolate the resulting vibration within the nozzle 110 where the energy can be most usefully applied.

In another aspect, a layer fusion system 132 may be used to encourage good mechanical bonding between adjacent layers of deposited build material within the object 112. This may include the ultrasound transducers described above, which may be used to facilitate bonding between layers by applying ultrasound energy to an interface between layers during deposition. In another aspect, current may be passed through an interface between adjacent layers in order to Joule heat the interface and liquefy or soften the materials for improved bonding. Thus in one aspect, the layer fusion system 132 may include a joule heating system configured to apply a current between a first layer of the build material and a second layer of the build material in the working volume 115 while the first layer is being deposited on the second layer. In another aspect, the layer fusion system 132 may include an ultrasound system for applying ultrasound energy to a first layer of the build material while the first layer is being deposited onto a second layer of the build material in the working volume 115. In another aspect, the layer fusion system 132 may include a rake, ridge(s), notch(es) or the like formed into the end of the nozzle 110, or a fixture or the like adjacent to the nozzle, in order to form energy directors on a top surface of a deposited material. Other techniques may also or instead be used to improve layer-to-layer bonding, such as plasma cleaning or other depassivation before or during formation of the interlayer bond.

During fabrication detailed data may be gathered for subsequent use and analysis. This may, for example, include a camera and computer vision system that identifies errors, variations, or the like that occur in each layer of an object. Similarly, tomography or other imaging techniques may be used to detect and measure layer-to-layer interfaces, aggregate part dimensions, diagnostic information (defects, voids, etc.) and so forth. This data may be gathered and delivered with the object to an end user as a digital twin 140 of the object 112 so that the end user can evaluate whether and how variations and defects might affect use of the object 112. In addition to spatial/geometric analysis, the digital twin 140 may log process parameters including, e.g., aggregate statistics such as weight of material used, time of print, variance of build chamber temperature, and so forth, as well as chronological logs of any process parameters of interest such as volumetric deposition rate, material temperature, environment temperature, and so forth.

The printer 100 may include a camera 150 or other optical device. In one aspect, the camera 150 may be used to create the digital twin 140 described above, or to more generally facilitate machine vision functions or facilitate remote monitoring of a fabrication process. Video or still images from the camera 150 may also or instead be used to dynamically correct a print process, or to visualize where and how automated or manual adjustments should be made, e.g., where an actual printer output is deviating from an expected output.

Other useful features may be integrated into the printer 100 described above. For example, a solvent or other material may be usefully applied a surface of the object 112 during fabrication to modify its properties. This may, for example intentionally oxidize or otherwise modify the surface at a particular location or over a particular area in order to provide a desired electrical, thermal optical, or mechanical property. This capability may be used to provide aesthetic features such as text or graphics, or to provide functional features such as a window for admitting RF signals.

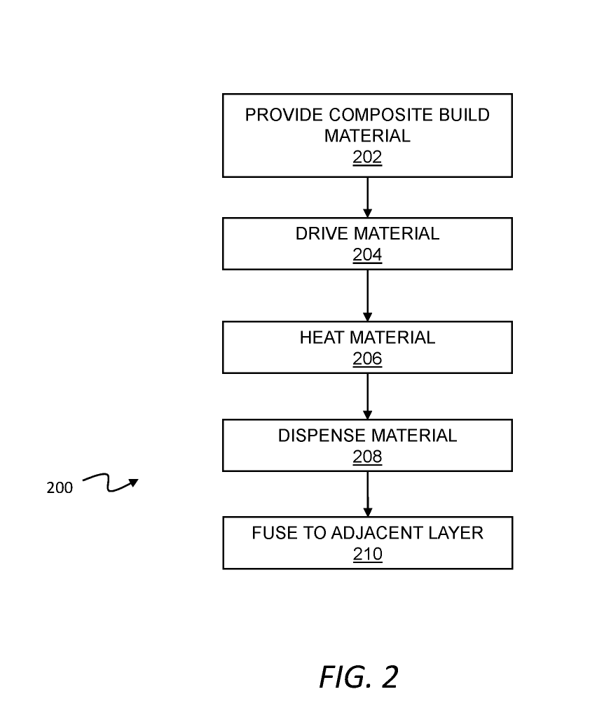

FIG. 2 shows a flow chart of a method for printing with composites.

As shown in step 202, the process 200 may include providing a build material including a composite formed of a metallic base that melts at a first temperature and a high temperature inert second phase that remains inert to at least a second temperature above the first temperature. The composite may include any of the metallic-ceramic composites, metallic-intermetallic-composites, or other composites described above. The composite may be provided as a build material in a billet, a wire, or any other cast, drawn, extruded or otherwise shaped bulk form. As described above, the build material may be further packaged in a cartridge, spool, or other suitable carrier that can be attached to an additive manufacturing system for use.

As shown in step 204, the process may include driving the build material using, e.g., gears, pistons or other drive mechanisms to propel the build material with sufficient force through a dispensing process and onto a substrate such as a build platform or a surface of a partially-fabricated object.

As shown in step 206, the process 200 may include heating the build material to a working temperature in a range between the first temperature and the second temperature. Within this temperature range, the composite will acquire a thick, pasty consistency suitable for extruding or otherwise dispensing onto a substrate in an additive manufacturing process.

As shown in step 208, the process 200 may include dispensing the build material substantially continuously through a nozzle in a controlled three-dimensional pattern to form an object. More generally, this may include dispensing through a nozzle, orifice, or other opening into a working volume. The dispensing operation may be coordinated with robotic movements in the controlled pattern to fabricate a three-dimensional object layer by layer from the dispensed build material.

As shown in step 210, the method may include fusing a first layer of the build material to a second layer of the build material. Numerous techniques may be used to facilitate this fusion process. For example, fusing may include applying a current across an interface between the first layer and the second layer of the object in order to heat/melt the interface through joule heating. In another aspect, fusing may include creating energy directors within a top surface of a bottom layer to provide concentrated locations for energy within the interface when a new layer is being applied. Fusing may also or instead include applying ultrasound energy while applying a new layer, which may advantageously be focused during initial contact with energy directors such as any of those described above.

This process may be continued and repeated as necessary to fabricate an object within the working volume. It will also be understood that while the steps above are illustrated as discrete, sequential steps, the order of these steps may vary significantly in practice. For example, heating and driving of build material may be performed concurrently or sequentially, and a heating process may be initiated before a drive system is engaged to advance build material through a machine. As another example, fusing may be selectively performed only at certain times during a fabrication process. Thus the flow chart is intended as an illustrative rather than exhaustive depiction of a useful fabrication process as contemplated herein.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. An apparatus comprising:
a build material including a composite formed of a metallic base that melts at a first temperature and a high temperature inert second phase in particle form that remains inert up to at least a second temperature greater than the first temperature;
a build plate within a working volume, the build plate including a surface that is rigid and substantially planar;
a liquefaction system configured to heat the composite to a working temperature within a range between the first temperature and the second temperature;
a nozzle that dispenses the build material at the working temperature; and
a robotic system configured to three-dimensionally position the nozzle within the working volume; and
a controller electrically coupled to the liquefaction system and the robotic system and operable to control the robotic system and the liquefaction system to fabricate an object in three-dimensions within the working volume from the build material.

2. The apparatus of claim 1 wherein the metallic base includes a pure metal.

3. The apparatus of claim 1 wherein the metallic base includes aluminum.

4. The apparatus of claim 1 wherein the metallic base includes an alloy.

5. The apparatus of claim 1 wherein the metallic base includes a eutectic alloy.

6. The apparatus of claim 1 wherein the metallic base includes a brazing filler metal.

7. The apparatus of claim 1 wherein a sufficient volume of the high temperature inert second phase is added to the composite to increase a viscosity of the composite at the working temperature by at least an order of magnitude.

8. The apparatus of claim 1 wherein the high temperature inert second phase consists of particles having a size not greater than five microns.

9. The apparatus of claim 1 wherein the high temperature inert second phase consists of particles having a size not greater than thirty microns.

10. The apparatus of claim 1 wherein the high temperature inert second phase comprises about thirty percent by volume of the composite.

11. The apparatus of claim 1 wherein the high temperature inert second phase comprises not more than forty percent by volume of the composite.

12. The apparatus of claim 1 wherein the high temperature inert second phase comprises between thirty to fifty percent by volume of the composite.

13. The apparatus of claim 1 wherein the high temperature inert second phase comprises at least one of an oxide, a nitride, and a silicon carbide.

14. The apparatus of claim 1 wherein the high temperature inert second phase comprises a high-temperature intermetallic.

15. The apparatus of claim 1 further comprising a joule heating system configured to apply a current between a first layer of the build material and a second layer of the build material in the working volume while the first layer is being deposited on the second layer.

16. The apparatus of claim 1 further comprising an ultrasound system for applying ultrasound energy to a first layer of the build material while the first layer is being deposited onto a second layer of the build material in the working volume.

17. The apparatus of claim 1 wherein a range for the working temperature includes a maximum temperature at least fifty degrees Celsius higher than the first temperature at which the metallic base melts.

18. The apparatus of claim 1 wherein the composite forms a paste at the working temperature within the range, the paste having a non-zero shear stress at zero shear strain.

19. An apparatus comprising:
a build material formed into a wire, the build material including a composite formed of a metallic base that melts at a first temperature and a high temperature inert second phase that remains inert to at least a second temperature above the first temperature; and
a carrier bearing the build material, wherein the carrier is configured to dispense the build material in a continuous feed to a three-dimensional printer.

20. The apparatus of claim 19 wherein the carrier includes a spool.

21. A method for operating a three-dimensional printer, the method comprising:
providing a build material including a composite formed of a metallic base that melts at a first temperature and a high temperature inert second phase that remains inert to at least a second temperature above the first temperature;
heating the build material to a working temperature in a range between the first temperature and the second temperature; and
dispensing the build material substantially continuously through a nozzle in a controlled three-dimensional pattern to form an object.

22. The method of claim 21 further comprising fusing a first layer of the build material to a second layer of the build material by applying a current across an interface between the first layer and the second layer.
